(19) United States
(12) Patent Application Publication
(10) Pub. No.: US 2013/0043277 A1
(43) Pub. Date: Feb. 21, 2013

(54) DISPENSING CLOSURE

(71) Applicant: Francis Lepage, Dommartin (FR)

(72) Inventor: Francis Lepage, Dommartin (FR)

(73) Assignee: OBRIST CLOSURES SWITZERLAND GMBH, Reinach (CH)

(21) Appl. No.: 13/511,576

(22) PCT Filed: Sep. 30, 2010
(86) PCT No.: PCT/GB2010/001838

§ 371 Date: Aug. 21, 2012

(30) Foreign Application Priority Data
Nov. 25, 2009 (GB) 0920609.5

(51) Int. Cl. B67D 7/76; B67D 3/00

(52) U.S. Cl. 222/189.07; 222/547; 210/800

(57) ABSTRACT

There is provided a dispensing closure (10) for a flowable product which tends to separate into a lighter fraction and a heavier fraction. The closure comprises a dispensing passageway (12) having an inlet (14) and an outlet (16) and through which product can dispensed, and a trap formed in the region of the inlet the entrance to which comprises a plurality (24) of slots through which, in use, the lighter fraction can pass for retention while preventing the flow of the heavier fraction into the trap so that it preferentially flows in the inlet for dispensing without the lighter fraction.

The present invention relates generally to a dispensing closure for a container and particularly to a dispensing closure for a flowable product.

Certain flowable products, such as ketchups and mustards, tend to separate over time into a lighter and a heavier fraction. The lighter fraction is less viscous than the heavier fraction and tends to separate from, and collect on top of, the heavier fraction. The lighter fraction, also sometimes referred to as “serum”, causes problems for conventional dispensing closures. This is because the lighter fraction will tend to reach a dispensing orifice before the heavier fraction; and in general consumers find dispensing of the lighter fraction undesirable.

The present invention seeks to address the problems with known dispensing closures.

According to a first aspect of the present invention there is provided a dispensing closure for a flowable product which tends to separate into a fighter fraction and a heavier fraction, the closure comprising a dispensing passageway having an inlet and an outlet and through which product can be dispensed, and a trap formed in the region of the inlet the entrance to which comprises a plurality of slots through which, in use, the tighter fraction can pass for retention whilst preventing the flow of the heavier fraction into the trap so that it preferentially flows into the inlet for dispensing without the lighter fraction.

Accordingly, the dispensing closure of the present invention can be attached to a container such that upon inversion of the container for dispensing, the lighter fraction immediately flows through the slots and into the trap whereas the more viscous heavier fraction (which will flow more slowly) will tend not to flow through the slots and in preference will flow into the inlet for dispensing through the passageway. The combination of the dispensing passageway together with the trap with slotted entrance therefore effectively filters the lighter fraction away from the heavier fraction so that the lighter fraction becomes trapped whereas the thicker, heavier fraction can flow through the passageway for dispensing.

According to a second aspect of the present invention there is provided a closure insert for a flowable product which tends to separate into a lighter traction and a heavier fraction, the closure comprising a dispensing passageway having an inlet and an outlet through which product can be dispensed, and a trap formed in the region of the inlet the entrance to which comprises a plurality of slots through which, in use, the lighter fraction can pass for retention whilst preventing the flow of the heavier fraction into the trap so that it preferentially flows into the inlet for dispensing without the lighter fraction.

The present invention can therefore be provided as an insert for a dispensing closure which could be supplied with, or retrofitted to, a container closure. The insert may be provided as a separate component which is fitted to a closure or may be formed as an integral part of a closure.

The trap slots may be defined by a plurality of fingers and in some embodiments the fingers may be shaped, for example curved. For ease of manufacture the fingers may be moulded in one position and shaped after moulding.

The fingers may form a generally dome-shape trap entrance. The fingers may therefore be formed as a plurality of “petals” which extend towards a central point, which in some embodiments is the passageway inlet.

The trap may be formed around the inlet. In other words, the slots may be positioned to extend from the region of the inlet to minimise the chance of lighter fraction entering the inlet.

The dispensing passageway may be generally tubular, with the trap formed around it.

The closure may be formed as a flip-top hinged closure. Other closure configurations are possible.

The present will now be more particularly described, by way of example, with reference to the accompanying drawings, in which:

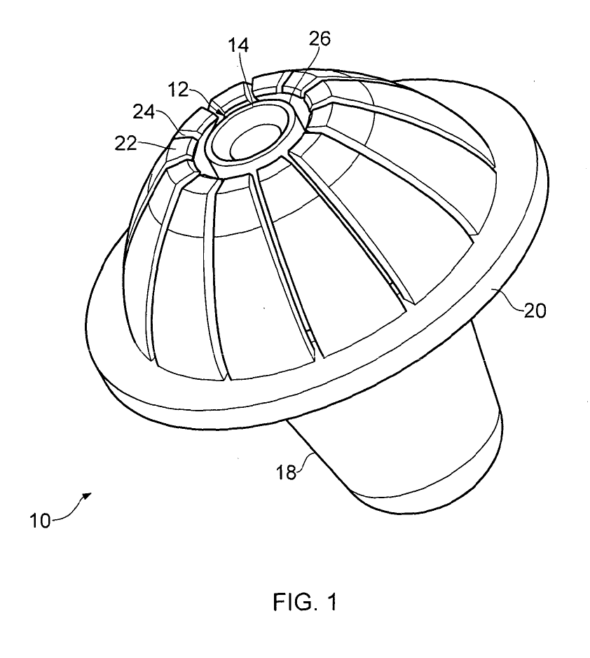

FIG. 1 is a perspective view of a serum trap device formed according to an embodiment of the present invention:

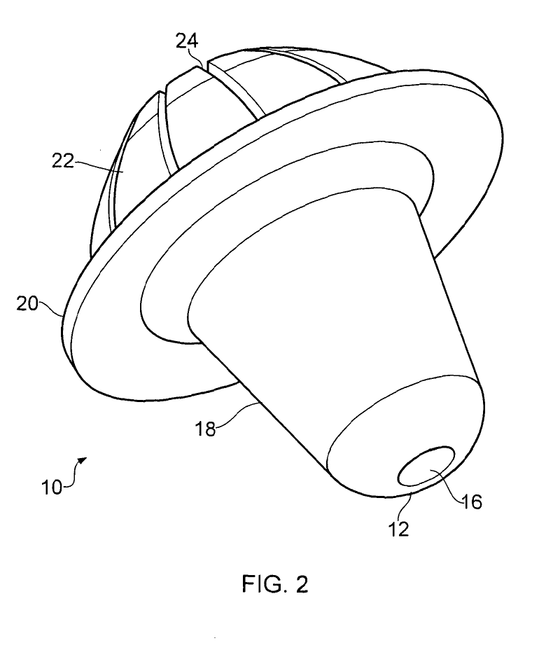

FIG. 2 is a further perspective view of the device of FIG. 1;

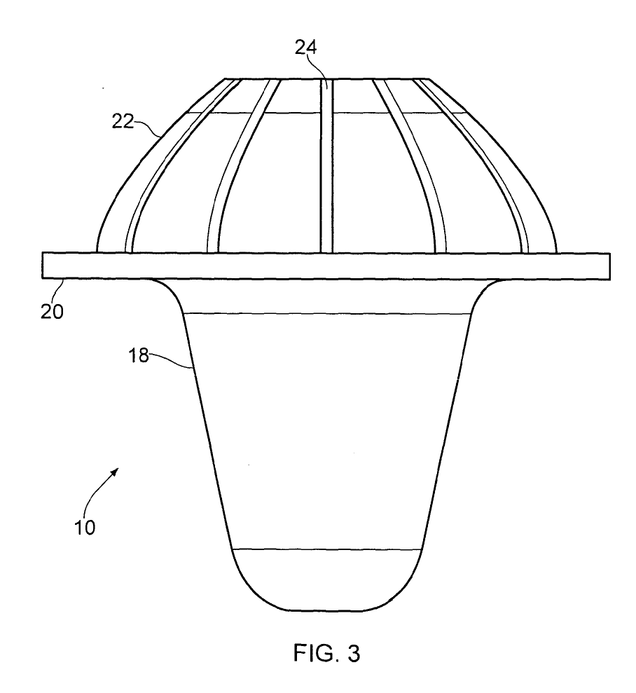

FIG. 3 is a side elevation of the device of FIG. 1:

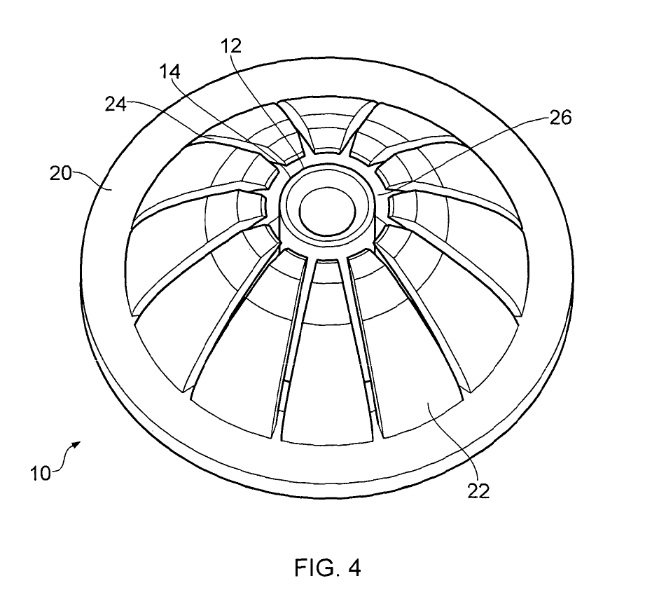

FIG. 4 is an under plan perspective view of the device of FIG. 1;

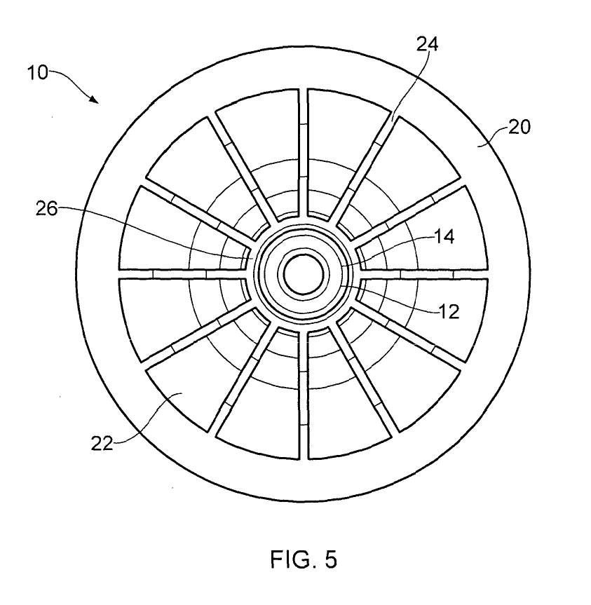

FIG. 5 is an under plan view of the device of FIG. 1;

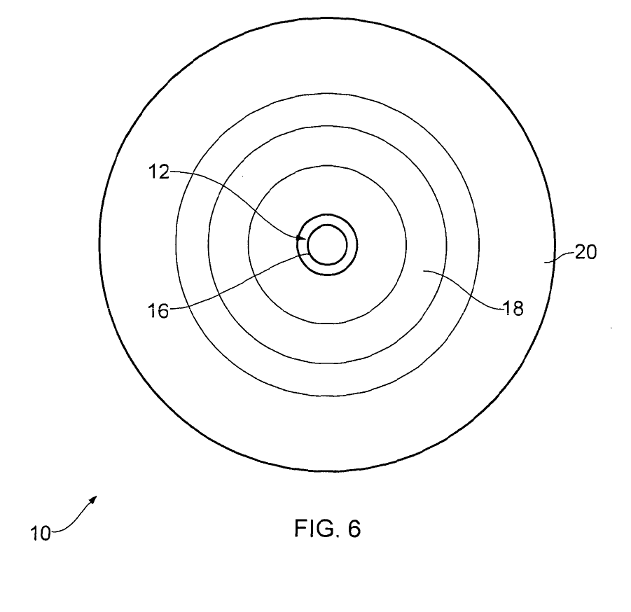

FIG. 6 is a plan view of the device of FIG. 1:

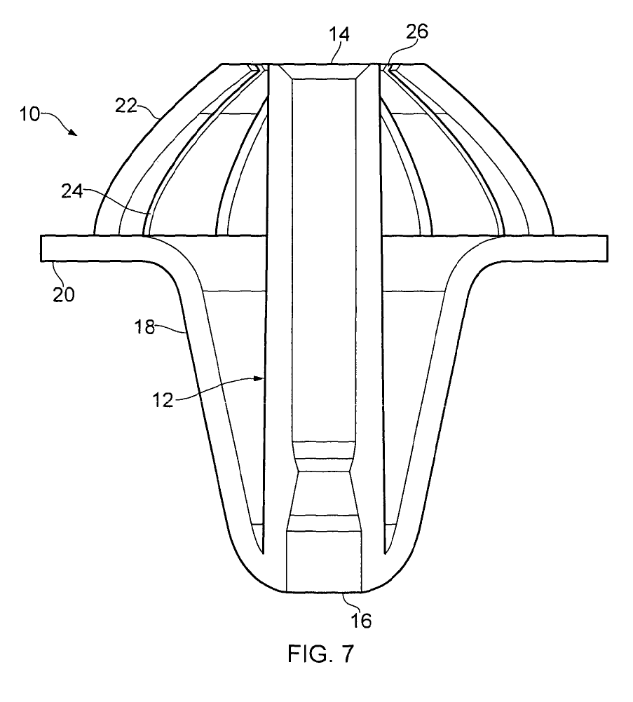

FIG. 7 is a section of the device of FIG. 1:

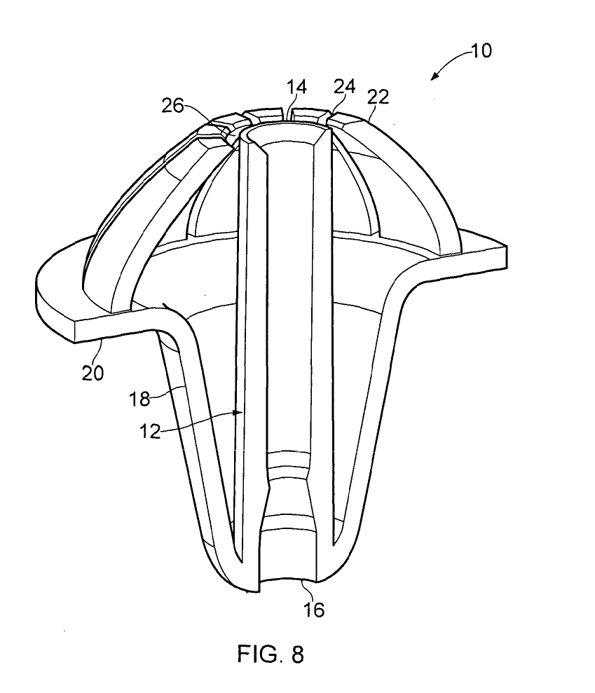

FIG. 8 is a perspective sectional view of the device of FIG. 1;

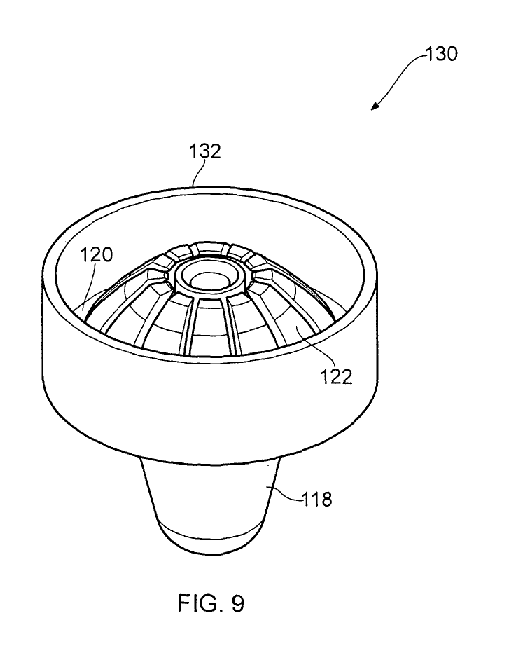

FIG. 9 is a perspective view of a serum trap closure formed according to an alternative embodiment of the present invention;

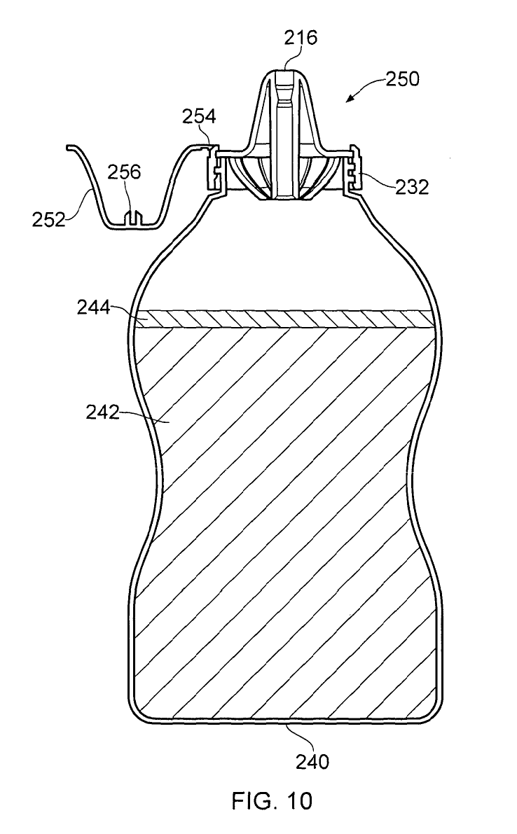

FIG. 10 is a section of a container provided with a dispensing closure formed according to an embodiment of the present invention:

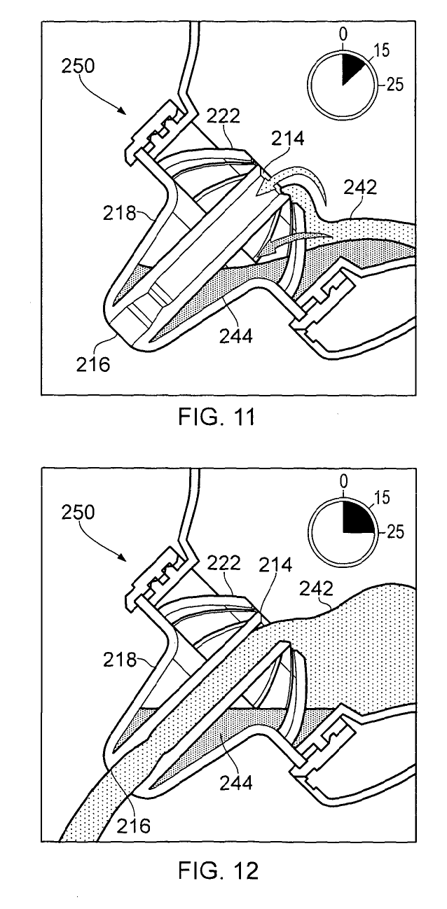

FIG. 11 is a diagrammatic representation of the closure of FIG. 10 in use following initial inversion of the container; and

FIG. 12 is a diagrammatic representation of the arrangement of FIG. 11 shown after further time has elapsed and dispensing has commenced.

Referring first to FIGS. 1 to 8 there is shown a serum trap device generally indicated 10. In this embodiment the device 10 is formed as an insert for a closure (not shown).

The device comprises a central tubular dispensing passageway 12 around which a serum trap arrangement is formed. The passageway 12 includes an inlet end 14 and an outlet end 16. In use, the inlet end 14 is positioned facing the interior of a container for receiving product which then flows through the passageway to the outlet end 16 for dispensing.

From the passageway end 16 a generally frusto-conical sidewall 18 extends approximately two thirds of the way towards the inlet end 14 coaxial to the passageway 12 and terminates with a radially outwardly extending flange 20.

The flange 20 carries a plurality (in this embodiment twelve) of fingers 21 which are curved and extend towards the end 14. The fingers 22 are mutually spaced so that slots 24 are formed between adjacent fingers 22. The fingers 22 are arranged to form a dome-like structure and the ends of the fingers 22 approach but do not touch the end 14 so that an annular gap 26 surrounds the end 14.

The result of this structure is that a serum trap is formed around the passageway 12 by the fingers 22 so that the lighter fraction of a product will preferentially flow through the slots 24 into the cavity formed by the sidewall 18, and the heavier fraction will preferentially flow into the end 14 for dispensing as described in more detail below.

Referring now to FIG. 9 there is shown a closure generally indicated 130 which is attachable to a container (not shown). The closure 130 is very similar to the device 10 shown in FIGS. 1 to 8 except the flange 120 is provided with a depending sidewall 132 which can be attached to a container, for example by the inclusion of screw thread formations or the like.

Referring to now FIG. 10 there is shown a container 240 for holding a flowable product, which in this embodiment is mustard, that tends to separate into a lighter fraction 244 and a heavier fraction 242 over time.

The container 240 is provided with a closure 250 which is very similar to the closure 130 shown in FIG. 9 except that a lid 252 is connected to the sidewall 232 by a hinge 254 so that it functions as a flip-top closure. The interior of the lid top plate is provided with a spigot 256 which, when the lid is in the closed position (not shown) fits into and seals the outlet 216.

Referring now to FIGS. 11 and 12 the working of the closure 250 is described.

When the container 240 is inverted both the lighter and heavier fractions 244, 242 flow towards the closure 250. The lighter fraction 244 is less viscous and flows faster. When the lighter fraction 244 reaches the closure it first reaches the fingers 222 and, due its viscosity, passes through the slots 224 and into the sidewall cavity; this means that the lighter fraction 244 does not pass into the inlet 214. The heavier fraction 242 travels more slowly towards the closure 250 and eventually reaches the fingers 222. Due to the viscosity of the heavier fraction 242 it does not pass through the slots 224 but rather flows over the fingers 222 and into the inlet 214 whereupon it can pass down the passageway 212 and be dispensed out of the outlet 216 whilst the lighter fraction 244 remains trapped around the passageway 218.

1-8. (canceled)

9. A dispensing closure for a flowable product which tends to separate into a lighter fraction and a heavier fraction, the closure comprising a dispensing passageway having an inlet and an outlet and through which product can be dispensed, and a trap formed in the region of the inlet the entrance to which comprises a plurality of slots through which, in use, the lighter fraction can pass for retention whilst preventing the flow of the heavier fraction into the trap so that it preferentially flows into the inlet for dispensing without the lighter fraction, in which the slots are defined by a plurality of fingers.

10. A dispensing closure insert for a flowable product which tends to separate into a lighter fraction and a heavier fraction, the closure comprising a dispensing passageway having an inlet and an outlet and through which product can be dispensed, and a trap formed in the region of the inlet the entrance to which comprises a plurality of slots through which, in use, the lighter fraction can pass for retention whilst preventing the flow of the heavier fraction into the trap so that it preferentially flows into the inlet for dispensing without the lighter fraction, in which the slots are defined by a plurality of fingers.

11. The closure as claimed in claim 1, in which the fingers are curved.

12. The closure as claimed in claim 1, in which the fingers form a generally dome-shaped trap entrance.

13. The closure as claimed in claim 1, in which the trap is formed around the inlet.

14. The insert of claim 2 in which the fingers are curved.

15. The insert of claim 2 in which the fingers form a generally dome-shaped trap entrance.

16. The insert of claim 2 in which the trap is formed around the in et.
